(19) United States
(12) Patent Application Publication
(10) Pub. No.: US 2014/0338261 A1
(43) Pub. Date: Nov. 20, 2014

(54) Modular aeroponic system and related methods

(71) Applicant: Chad Colin Sykes, Houston, TX (US)

(72) Inventor: Chad Colin Sykes, Houston, TX (US)

(21) Appl. No.: 14/120,275

(22) Filed: May 14, 2014

Related U.S. Application Data
(60) Provisional application No. 61/823,330, filed on May 14, 2013.

(51) Int. Cl. A01G 31/02; A01G 1/00

(52) U.S. Cl. CPC A01G 31/02; A01G 1/001
USPC 47/62 A; 47/59 R

(57) ABSTRACT

Disclosed is a modular aeroponic system that accommodates different support-mediums and misting or spray configurations. In one embodiment, the disclosed system comprises: a root chamber with plumbing that is coupled to a nutrient distribution system; a first interchangeable-lid for the root chamber that functions as a first type of support medium; a second interchangeable-lid defined a surface by a plurality of net pot receptacles for retaining a plurality of net pot support mediums; a first spray-nozzle manifold that may be removably coupled to the plumbing of the root chamber and featuring spray nozzles in a first configuration; a second spray-nozzle manifold that may be removably coupled to plumbing of the root chamber and featuring spray nozzles in a second configuration; wherein the first and second lid may be interchangeably applied to the root chamber; and wherein the first and second manifold may be interchangeably coupled to the root chamber's plumbing.

### CROSS-REFERENCE TO RELATED APPLICATIONS

This application claims the priority and benefit of U.S. Prov. Pat. App. Ser. No. 61/823,330 (filed May 14, 2013) entitled “Modular aeroponic system and related methods.” This document is hereby incorporated by reference in its entirety.

### STATEMENT REGARDING FEDERALLY SPONSORED RESEARCH OR DEVELOPMENT

Not applicable.

### BACKGROUND OF THE INVENTION

1. Field of Invention

The subject matter of this disclosure is in the field of modular aeroponic systems for growing herbs, leafy greens and micro-greens. More specifically, said subject matter is in the field of aeroponic systems with multiple support mediums.

2. Background of the Invention

Aeroponics is a process for growing plants wherein roots are provided to an air or mist environment rather than soil. In operation, Aeroponics is basically accomplished via suspending a plant's roots through a support medium into a closed environment wherein nutrients and other sustenance (e.g., a nutrient rich water solution) for the plant are sprayed or misted onto the dangling roots while the leaves and crown of the plant (also known as the canopy) extend upwardly from the support-medium. Aeroponics is frequently used for urban or indoor gardens because space and soil can be limited in those areas.

Various types of support mediums are employed in aeroponic systems. Usually, the support-medium of an aeroponic system will be tailored to the plant to be grown. For example: microgreens (e.g., are best grown aeroponically using a wire-mesh or screen as a support medium so that the same can be grown in bulk; whereas herbs and other leafy greens are preferably grown individually in net pots. Not surprisingly, the configuration of the spray or mist system of an aeroponic environment will vary depending on the support structure employed because, among other things, distribution of the plants dangling roots is typically different in one support medium versus another.

The dependence of a preferred support medium and spray or mist system configuration on the plant to be aeroponically grown can be problematic. For instance, a person desirous of growing both microgreens on a mesh, screen and herbs or leafy greens in net pots may have to learn the operating procedures for two different aeroponic systems. That is to say: support mediums and mist systems are not interchangeable between aeroponic systems. Frankly, a need exists for an aeroponic system that can readily employ or accommodate different types of support mediums so that multiple types of plants can be grown using the same system.

### SUMMARY OF THE INVENTION

In view of the foregoing, it is an objective of this disclosure to describe an aeroponic system configured to accommodate different support-mediums and corresponding mist system configurations. In one embodiment, the disclosed system comprises: a root chamber with a bulkhead fitting coupled to a nutrient supply manifold of a nutrient distribution system; a first interchangeable-lid for the root chamber defined on surface by a mesh screen that is operationally configured to be a support medium; a second interchangeable-lid defined on the surface by a plurality of net pot receptacles for retaining a plurality of net pot support mediums; a first spray-nozzle manifold that may be removably coupled to the bulkhead fitting of the root chamber and featuring a plurality of spray nozzles distributed across the first spray-nozzle manifold in a first configuration; a second spray-nozzle manifold that may be removably coupled to the bulkhead fitting of the root chamber and featuring a plurality of spray nozzles distributed across the second spray nozzle manifold in a second configuration; wherein the first and second lid may be interchangeably applied to the root chamber; and wherein the first and second manifold may be interchangeably coupled to the bulk-head fitting. In one preferred method of use: a user may first install the first spray-nozzle manifold and employ the first lid as a support medium for aeroponically growing a first plant; second, a user may remove the first lid and uninstall the first spray-nozzle manifold when the first plant is full-grown; finally, a user may install the second spray-nozzle manifold and employ the second lid over the root chamber to support net pots for aeroponically growing a second plant.

### BRIEF DESCRIPTION OF THE FIGURES

Other objectives of the invention will become apparent to those skilled in the art once the invention has been shown and described. The manner in which these objectives and other desirable characteristics can be obtained is explained in the following description and attached figures in which:

FIG. 1 an exploded perspective view of an aeroponic system;

FIG. 2 a perspective view of shelving for the aeroponic system of FIG. 1;

FIG. 3 is a schematic for a nutrient delivery system;

FIG. 4 is a detailed view of the nutrient delivery system; and,

FIG. 5 a schematic of a plurality of aeroponic systems coupled to the nutrient delivery system.

It is to be noted, however, that the appended figures illustrate only typical embodiments of the disclosed apparatus and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

Disclosed is a modular aeroponic system configured to accommodate different support-mediums and corresponding misting or spray configurations. In one embodiment, the disclosed system comprises: a root chamber with plumbing that is coupled to a nutrient distribution system; a first interchangeable-lid for the root chamber that functions as a first type of support medium; a second interchangeable-lid defined a surface by a plurality of net pot receptacles for retaining a plurality of net pot support mediums; a first spray-nozzle manifold that may be removably coupled to the plumbing of the root chamber and featuring spray nozzles in a first configuration; a second spray-nozzle manifold that may be removably coupled to plumbing of the root chamber and featuring spray nozzles in a second configuration; wherein the first and second lid may be interchangeably applied to the root chamber; and wherein the first and second manifold may be interchangeably coupled to the root chamber's plumbing. In one preferred method of use: a user may match support structures with a corresponding spray-nozzle manifold by interchanging the lids and manifolds. The more specific details of the disclosed aeorponic system are described with reference to the figures.

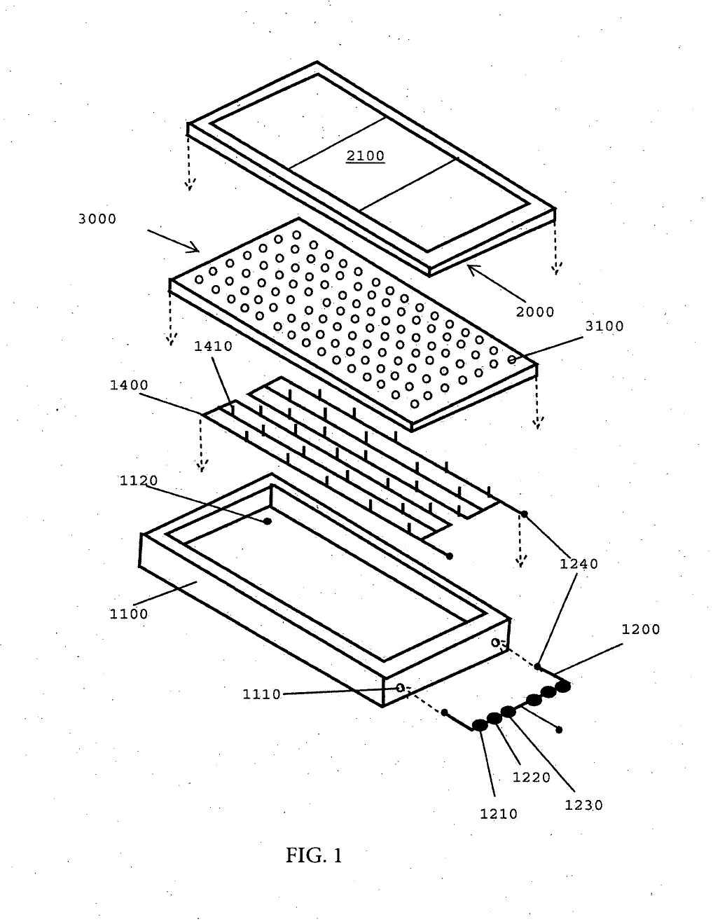

FIG. 1 is an exploded perspective view of a preferred embodiment of an aeroponic system fixture 1000. As shown, the fixture 1000 comprises: a root chamber 1100; a nutrient delivery manifold 1200; a bulkhead fitting 1110; a first spray-nozzle manifold 1400; a first lid 2000; and a second lid 3000.

As shown in FIG. 1, the root chamber 1100 may be an open and water retaining box (e.g., 48″×96″×12″). Preferably, a bulk-head fitting 1110 has been provided through the root chamber 1100 so that, as discussed below, the nutrient delivery system may be coupled to a spray nozzle manifold installed within the root chamber 1100. Suitably, the root chamber features a drain 1120 (e.g., a 1½″ drain in the bottom of the root chamber 1100). In a preferred embodiment, the root chamber 1100 may be spun, molded of high density polyethylene so that the same are easy to machine using regular hand tools.

Still referring to FIG. 1, a spray-nozzle manifold 1400 may be installed within the root chamber 1100. In a preferred embodiment, the spray nozzle manifold 1400 is defined by a piping with a plurality of nozzles positioned at various locations along the piping (e.g., 1″ PVC piping). Suitably, the manifold may be removably installed in the root box 1100 via coupling the piping to the bulkhead fitting 11100, (e.g., via pipe unions 1240). As discussed later below, the manifold may suitably spray nutrients upward from the bottom of the root chamber 1100. Preferably, a plurality of manifolds 1400 may be interchangeably installed in the root chamber 1000 wherein said manifolds feature customizable configurations to provide a variety of nozzles and nozzle spacing. In a preferred embodiment, the nozzles suitably provide a 50-60 micron atomized mist that provides water and nutrients to root structures growing within the root chamber 1100.

Yet still referring to FIG. 1, the root chamber 1000 may be coupled to nutrient delivery manifold 1200. In operation, the spray-nozzle manifold 1400 may be provided pressurized nutrient solution by way of the nutrient supply manifold 1200. The nutrient supply manifold 1200 consists of a high pressure on-demand diaphragm style pump 1210 that provides up to 100 PSI of pressure. In a preferred embodiment, an accumulator 1230 is attached to the pump to reduce pump cycling and water hammer. Operably, the system may be activated by way of a solenoid valve 1220 which is operated by a user provided recycle timer or other timing device. The solenoid valve 1220 is typically normally closed so that, when activated, pressure is provided to the spray-nozzle manifold 1400. Suitably, whenever the pressure of the system drops below 80 PSI, the on-demand pump 1210 automatically brings the pressure back up to 100 PSI. Suitably, the entire manifold 1200 system is connected using pipe unions 1240 making the system easy to maintain.

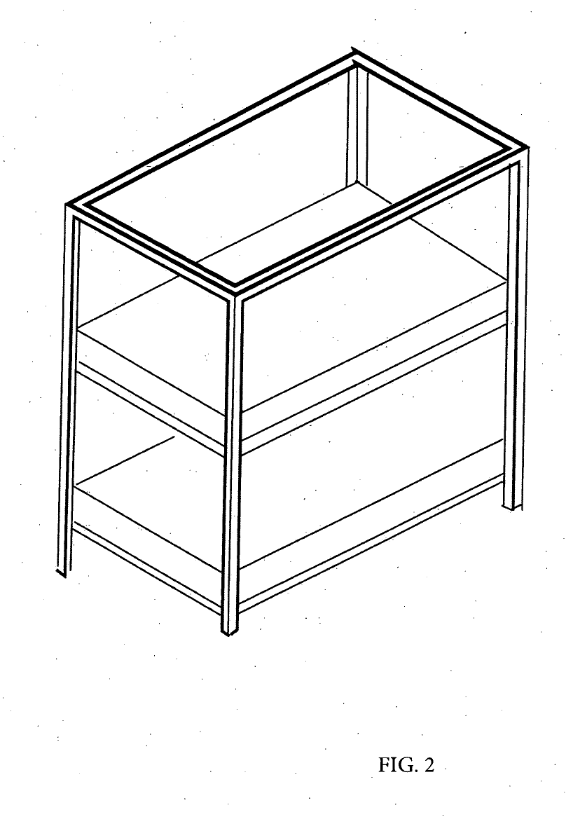

FIG. 1 also shows two interchangeable lids 2000, 3000 for the root chamber 1100. The interchangeable modular lids 2000, 3000 preferably allow a variety of different plant growth environments. The first modular lid 2000 is configured for receiving a growth mat (of fibrous material) (not shown) on a mesh screen 2100. The second modular lid 3000 features a plurality of receptacles 3100 for supporting net pots. Referring to the drawing, the first lid 2000 design may be configured to accept off-the-shelf 4×8 grow mats and, to this end, may feature a stainless steel frame that supports a stainless steel mesh 2100. In the second style lid 3000, receptacles 3100 for net pots may be machined to accept any number, size or spacing of net pots (e.g., the lid design may offer an assortment holes and spacing, or users can order blank lids and drill the holes themselves). In one embodiment, your lids 2000, 3000 lids and root chamber 1100 may be spun molded of high density polyethylene so that the same are easy to machine using regular hand tools. In a preferred operation, multiple fixtures 1000 may be employed simultaneously to aeroponically grow plants and a shelving system (shown in FIG. 2) may be employed to consolidate the surface area used by the multiple fixtures.

In operation the disclosed fixtures 1000 may be used to aeroponically grow plants. Suitably, a plant may be provided to the support medium located in the lid 2000, 3000 wherein the plants roots dangle into the root chamber 1100. Nutrients and sustenance may be provided to the plant roots via the spray-nozzles 1410 of the spray-nozzle manifold. Unabsorbed nutrients may suitably collect in the root chamber 1100 and escape via the drain 1120.

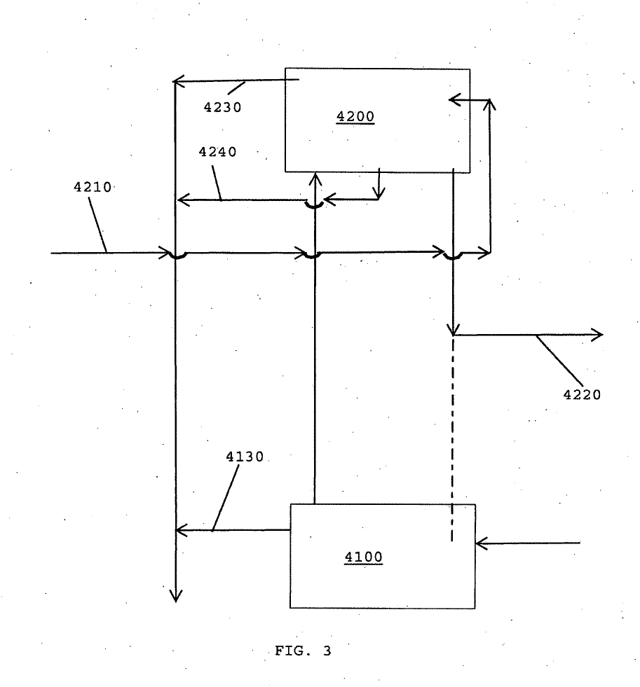

As alluded to above, the nutrient delivery manifold 1400 is coupled to a nutrient delivery system 4000. FIG. 3 is a schematic of a preferred nutrient delivery system 4000 that may be employed with the fixtures 1000. Referring to FIG. 3, the nutrient delivery system preferably features two 50 gallon tanks 4100, 4200. Suitably, a first tank 4200 features a water inlet stream 4210 wherein water may be filtered, mixed with nutrients and provided to the tank 4200 for storage. Suitably, the nutrient solution in the tank 4200 may be delivered to the fixtures via an outlet line 4220. After being provided to the fixtures and sprayed into the root chamber, unused nutrient solution is returned via recycle line 4110 to the other tank 4100. The pooled recycle line of the other tank 4100 is filtered through a filter line 4120 and returned to the nutrient tank 4200 so that the process may be repeated using a mixture of fresh and recycled nutrient solution. Suitably, both tanks 4100, 4200 feature an overflow line 4130, 4230 so that spilled nutrient solution can be avoided. Finally the nutrient solution tank 4200 may feature a drain 4240.

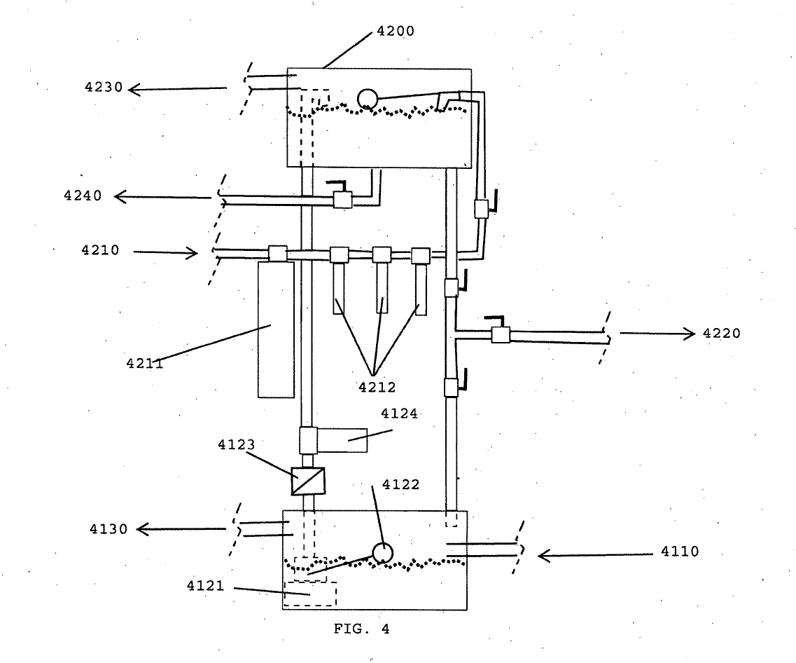

FIG. 4 is a more detailed description of the nutrient delivery system 4000 of FIG. 3. A water inlet line 4210 may be provided to the first tank 4200. As shown, water may be provided through a reverse osmosis system 4211 for purification. Next the purified water may pass through a series of dosatrons 4212 which automatically mix nutrients into the water. The nutrient water solution may then be provided to the tank 4200. Suitably, the inlet to the tank features a float valve 4213 that allows nutrient solution into the tank 4200 whenever the nutrient solution level falls below a pre-set level. Suitably, the nutrient solution in the tank 4200 may be delivered to the fixtures via an outlet line 4220. After being provided to the fixtures 1000 and sprayed into the root chamber 1100, unused nutrient solution is returned via the recycle line 4110 to the other tank 4100. Suitably, the recycle tank 4100 features a filter line 4110 for returning the recycled nutrient solution to the nutrient tank 4200. In one embodiment, the filter line 4120 features a pump 4121 with a float valve 4122 so that the pump may activate when the nutrient solution level of the tank 4100 rises to a pre-set level. Preferably, the filter line 4120 further features a check-vale 4123 and a 1 micron filter 1424 so that the used nutrient solution can be cleanly provided to the nutrient tank 4200. Suitably, both tanks 4100, 4200 feature an overflow line 4130, 4230 so that spilled nutrient solution can be avoided. Finally the nutrient solution tank 4200 may feature a drain 4240.

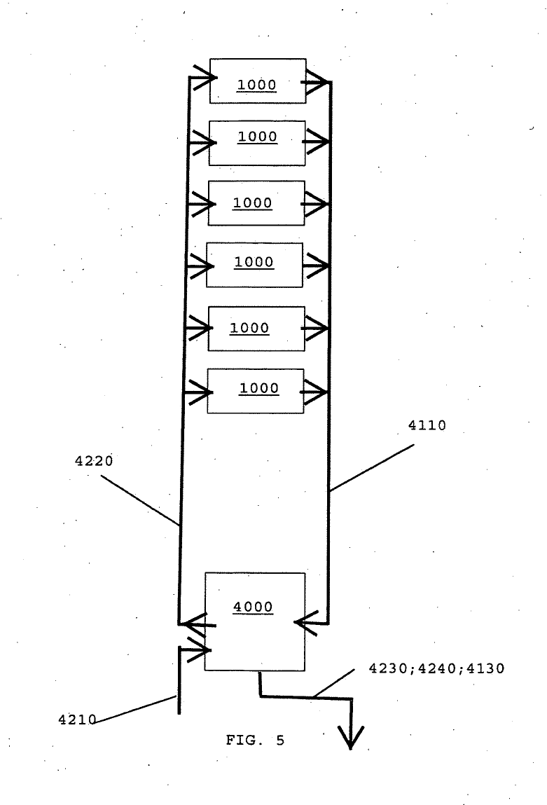

FIG. 5 is a schematic showing the disclosed aeroponic system. As shown, the system may be defined by the nutrient delivery system 4000 and a plurality of fixtures 1000.

It should be noted that this disclosure describes a preferred embodiment and is not intended to be limiting of the possible embodiments that could be used to accomplish the invented aeroponic systems. Those of skill in the art may readily appreciate other useful and equally preferred embodiments of the disclosed aeroponic system after reading this disclosure and such embodiments would not depart from the spirit and intent of this disclosure.

I claim:

1. An aeroponic system with interchangeable support mediums and spray systems comprising:
a root chamber with a bulkhead fitting coupled to a nutrient supply manifold of a nutrient distribution system;
a first interchangeable-lid for the root chamber defined on a surface by a mesh screen that is operationally configured to be a support medium;
a second interchangeable-lid defined on a surface by a plurality of net pot receptacles for retaining a plurality of net pot support mediums;
a first spray-nozzle manifold that may be removably coupled to the bulkhead fitting of the root chamber and featuring a plurality of spray nozzles distributed across a first spray-nozzle manifold in a first configuration; and,
a second spray-nozzle manifold removably coupled to the bulkhead fitting of the root chamber and featuring a plurality of spray nozzles distributed across a second spray nozzle manifold in a second configuration.

2. An aeroponic system according to claim 1 wherein the first and second manifold may be interchangeably coupled to the bulkhead fitting.

3. An aeroponic system according to claim 1 wherein the root chamber features a drain approximately 1½ inches deep in the bottom of the root chamber.

4. An aeroponic system according to claim 1 wherein the nutrient supply manifold consists of a high pressure on-demand pump.

5. An aeroponic system according to claim 4 wherein an accumulator is attached to the pump.

6. An aeroponic system according to claim 5 wherein the pressure is set at approximately 100 PSI.

7. An aeroponic system according to claim 6 wherein the on demand pump automatically brings the system back to approximately 100 PSI when the pressure drops below approximately 80 PSI.

8. An aeroponic system according to claim 1 wherein the system is activated by way of a solenoid value that is operated by a user provided recycle timer.

9. An aeroponic system according to claim 1 wherein the root chamber, first lid, and second lid are constructed from high density polyethylene.

10. An aeroponic system according to claim 1 wherein the nutrient deliver system comprises:
two tanks;
a water inlet stream connected to the first tank;
an outlet line connected to the first tank that delivers the nutrients to the root chamber;
a recycle line that returns unused nutrients to the second tank; and,
a filter line that returns filters nutrients and returns them to the first tank.

11. An aeroponic system according to claim 10 wherein the nutrient delivery system features two tanks capable of holding approximately 50 gallons of liquid.

12. A method of growing plants aeroponically comprising:
obtaining a root chamber with a bulkhead fitting;
coupling the bulkhead to a nutrient supply manifold of a nutrient distribution system;
obtaining a first lid to the root chamber wherein the lid is defined on a surface by a mesh screen that is operationally configured to be a support medium;
obtaining a second lid to the root chamber wherein the second lid consists of a plurality of net pot receptacles for retaining a plurality of net pot support mediums;
installing a first spray-nozzle manifold and employing the first lid as a support medium for growing of a first plant;
installing a second spray-nozzle manifold;
employing the second lid over the root chamber to support net pots for aeroponically growing a second plant; and,
removing the first lid and uninstalling the first spray-nozzle manifold when the first plant is fully grown.
